(19) United States
(12) Patent Application Publication
(10) Pub. No.: US 2006/0214333 A1
(43) Pub. Date: Sep. 28, 2006

(54) Polymer film and production method thereof

(75) Inventor: Hiroshi Miyachi, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/389,119

(22) Filed: Mar. 27, 2006

(30) Foreign Application Priority Data
Mar. 25, 2005 (JP) 2005-087627

(51) Int. Cl. B29C 67/24

(52) U.S. Cl. 264/330; 428/400

(57) ABSTRACT

A dope produced from cellulose acylate, solvent and additive, is cast on a belt and peeled as a film containing the solvent, with use of a peel roller. Then the film is dried to a film. After the peeling, the film is transported with use of plural rollers in an transfer section. Each roller is provided with a temperature controlling device for controlling the surface temperature of each roller. A surface temperature is controlled in the range of Tm (° C.) to Tm+50 (° C.), if the melting point of the additive for the dope is described as Tm (° C.). While the drying is made with support of the roller, the transporting becomes stable, and the roll-print defects and the scratch defects are reduced. Thus the produced film is excellent in smoothness and optical properties.

### BACKGROUND OF THE INVENTION

1. Field of the Invention

The present invention relates to a polymer film and a production method thereof.

2. Description Related to the Prior Art

A liquid crystal display (hereinafter LCD) is widely used for a TV monitor and a monitor of a personal computer or a cell phone, since the voltage and an electric power consumption of the LCD are low and the LCD can be smaller and thinner. Generally, the LCD is constructed of optical materials, such as a liquid crystal cell, an optical compensation sheet, a polarizer and the like. In the field of the optical materials, several sorts of polymer films are used, depending on use, such as protection of a polarizing filter, prevention from the image coloring, widening of view angles, and the like.

A representative of the polymer films is a cellulose acylate film. There are several merits of the cellulose acylate film. For example, the cellulose acylate film has large birefringent index and high retardation and can be used as a protective film for the polarizing filter. Because of the merits, the cellulose acylate film is widely used as polymer film in order to supply a cheap and thin liquid crystal display. Concretely, in the liquid crystal display, the cellulose acylate film is used as protective film for the polarizing filter, a color filter, a protective film in the liquid crystal display for a computer. Especially, the cellulose acylate film is used as the protective film of the liquid crystal display more frequently in recent years. Further, the cellulose acylate film is used not only as the protective film, but also several functions are provided to the cellulose acylate film. Thus a film for widening the view angle (for example, WV film, produced by Fuji Photo Film Co. Ltd.), an antireflection film of a liquid crystal television (for example, CV film, produced by Fuji Photo Film Co. Ltd.), and the like are obtained and used.

The polymer film including the several sorts of the cellulose acylate films is produced by a solution casting method. In the solution casting method, a polymer solution as mixture of polymer (cellulose acylate and the like), solvent and additive is filtrated with use of a filtration device, such that a dope may be obtained. Then the dope is cast onto a running support and peeled as a film containing solvent. The film is dried with a drying device, and thus a film is obtained.

In the film production, the film containing the solvent is stretched during the drying thereof, so as to increase the optical properties (mainly retardation). Further, in order to dry the film, plural drying sections of different temperatures are provided, and the film is sequentially transported through the drying sections. As the drying sections, there are for example a transfer section in which the film is dried with support by rollers, a tenter dryer in which the film is dried with both side edge portions clipped such that the content of the remaining solvent in the film may be a predetermined value, and a drying chamber in which the film is dried enough. In followings, the processes of the transfer section, the tenter dryer and the drying chamber are respectively called first drying process, second drying process and third drying process.

In these drying process, a surface temperature of the film is increased over an apparent value of glass transition temperature Tg (° C.) of a film surface. Thus the solvent in the film can be evaporated efficiently, and creases, wrinkles, curls and the like are prevented. Note that the apparent value of Tg means that a value of the glass transition temperature of the mixture material composed of plural materials having different glass transition temperatures Tg. In Japanese Patent Laid-Open Publication No. 2001-315147, a film transporting members, for example rollers, are disposed in staggered arrangement in an area between peeling the film containing solvent and drying, such that the surface temperature of the film may be kept in the range of 50° C. to 100° C. It takes from 10 to 70 seconds to transports the film through the area. Thus the curling of the film is prevented.

However, if the film is heated to high temperature such as in the method of the publication No. 2001-315147 or over the apparent value of Tg, not only the solvent compounds but also the additive compounds evaporate to generate additive vapor in a drying atmosphere in the drying equipments. Especially, the plasticizer, one of the additive compounds, has low boiling point and therefore evaporates easily.

In the transfer section, there are no partitions. Therefore, if the concentration of the plasticizer vapor increases in the tenter dryer during the evaporation, the concentration of the plasticizer vapor in the transfer section also increases proportionately. In the drying, the latent heat of evaporation of the solvent and the additive such as the plasticizer and the like causes to decrease the surface temperature of the film. Therefore, in the transfer section, the latent heat of evaporation also cools the rollers supporting the film.

If contacting to the cooled rollers, the plasticizer vapor liquidizes, deposits and accumulates. The deposited or accumulated plasticizer from the plasticizer vapor (hereinafter accumulated foreign materials) contacts to the film surface while the film is transported with the rollers. Thus the accumulated foreign materials adheres to the film surface (roll-print defects) and scratches the film surface (scratch defects), which causes the surface defects to extremely decrease the optical properties.

### SUMMARY OF THE INVENTION

An object of the present invention is to provide a polymer film for obtaining a film excellent in optical properties and evenness by reducing surface defects caused by roll-print defects and scratch defects while a film is transported with supporting by the rollers as in an transfer section and the like.

Another object of the present invention is to provide a production method for producing a film excellent in optical properties and evenness by reducing surface defects caused by roll-print defects and scratch defects while a film is transported with supporting by the rollers as in an transfer section and the like.

In order to achieve the object and the other object, in a film production method with use of a polymer solution containing polymer, solvent and additive, the polymer solution is cast onto a running support to form a casting film, and the casting film in a situation of containing the solvent is peeled as a film from the support. Then a first drying of the film is performed by plural rollers whose temperatures are independently controlled.

As a preferable embodiment of the present invention, when melting point of the additive is described as Tm (° C.), a temperature of each roller is controlled in the range of Tm (° C.) to Tm+50 (° C.).

Preferably, in the present invention, a second drying of the film is further made by heating the film with use of a tenter dryer. The tenter dryer stretches and relaxing the film in a widthwise direction while transporting the film. An ambient temperature of the film is controlled almost to a predetermined value while a width of the film is changed by stretching and relaxing. keeping an inner temperature of teh tenter dryer higher than an outer temperature thereof, while the film is stretched and transported in the tenter dryer. The innter temperature is controlled almost constant while a width of the film changes in the tenter dryer.

Preferably, the film is cellulose acylat.

Further, the present invention includes a polymer film produced by the above film production method.

According to the present invention, after the casting film formed from the polymer solution is peeled as the film from the support, a first drying of the film is performed in an transfer section by the plural rollers whose temperatures are controlled independently. Thus the film is transported with the rollers whose surface temperatures are independently controlled. Therefore, the transport of the film is made stably in the transfer section.

Further, when melting point of the additive is described as Tm (° C.), a temperature of each roller is controlled in the range of Tm (° C.) to Tm+50 (° C.). Therefore, even if the additive vapor dews on the rollers in the transfer section, the condensed solvent evaporates again. Thus, the adhesion or accumulation of the solvent compounds on the rollers is prevented, such that a surface of each roller can be kept smooth and clean. As a result, the copy of pollution onto the film and the scratch of the film surface can be prevented, and the produced film is excellent in the planarity. Actually, if the additive vapor contact to the roller, the additive vapor melts or adsorbed to the roller and then are copied onto the film transported by the rollers uniformly. Further, the plasticizer vapor sometimes dews on the film surface. However, the surface defects don't occur in these cases, and the quality is good. Note that in the drying process, since the film is always heated, the plasticizer in the liquid state on the film surface probably evaporates again or adsorbed into the film.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a flow chart of processes for producing a cellulose acylate film of the present invention;

FIG. 2 is a schematic diagram of a dope production line in the prevent invention;

FIG. 3 is a schematic diagram of a film production line as an embodiment of the production method of the film of the present invention;

FIG. 4 is an exploded view of an transfer section in the film production line of FIG. 3.

### PREFERRED EMBODIMENTS OF THE INVENTION

As polymer, cellulose acylate is especially preferable. However, the polymer is not restricted in cellulose acylate. As for cellulose acylate, it is preferable that the degree of substitution of acyl groups for hydrogen atoms on hydroxyl groups of cellulose preferably satisfies all of following formulae (I)-(III).
2.5≦A+B≦3.0 (I)
0≦A≦3.0 (II)
0≦B≦2.9 (III)

In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 mass% of TAC is particles having diameters from 0.1 mm to 4 mm.

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particylarly2.22 to 2.90, and especially 2.40 to 2.88. Further, DS6/(DS2+DS3+DS6) is preferably at least 0.28, particularly at least 0.30, and especially 0.31 to 0.34.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl groups, the total degree of substitution is described as DSB. In this case, the value of DSA+DSB is preferably 2.22 to 2.90, especially 2.40 to 2.88. Further, DSB is preferably at least 0.30, and especially at least 0.7. According to DSB, the percentage of the substitution on the 6^{th} position to that on the 2^{nd}, 3^{rd} and 6^{th} positions is at least 20%. However, the percentage is preferably at least 25%, particularly at least 30%, and especially at least 33%. Further, DSA+DSB of the 6^{th} position of the cellulose acylate is preferably at least 0.75, particularly at least 0.80, and especially at least 0.85. When these sorts of cellulose acylate are used, a solution (or dope) having excellent solubility can be produced. Cellulose acylate is may be produced from cotton linter or cotton pulp, and preferably cellulose acylate is produced from cotton linter.

In cellulose acylate, the acyl group having at least 2 carbon atoms may be aliphatic group or aryl group, and is not restricted especially. Such cellulose acylate is, for example, alkylcarbonyl ester and alkenylcarbonyl ester of cellulose. Further, there are aromatic carbonyl ester, aromatic alkyl carbonyl ester, or the like, and these compounds may have other substituents. As preferable examples of the compounds, there are propionyl group, butanoyl group, pentanoly group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chloroform, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like.

The solvents are preferably hydrocarbon halides having 1 to 7 carbon atoms, and dichloromethane. Then in view of the solubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable, and a mixture thereof can be used. These ethers, ketones and esters may have the ring structure. Further, the compounds having at least two of functional groups (namely, —O—, —CO— and —COO—) in ethers, ketones and esters can be used for the solvent. Further, the solvent may have other functional groups, such as alcoholic hydroxyl groups, in the chemical structure.

The detail explanation of cellulose acylate is made from [0140] to [0195] in Japanese Patent Laid-Open Publication No. 2005-104148. The description of this publication is also applied to the present invention. Further, the additives (such as the solvent, plasticizer, deterioration inhibitor, UV absorbing agent, optically anisotropic controller, retardation controller, dyne, matting agent, release agent, releasing accelerator and the like) are described in detail from [0196] to [0516] of Japanese Patent Laid-Open Publication No. 2005-104148.

The film produced from the cellulose acylate dope of the present invention can be used for a polarizing filter, as a member of a liquid crystal display, and so on, because of a high dimensional stability. However, in view of inhibiting the deterioration under the circumstances in which the polarizing filter, the liquid crystal display or the like is used, the UV-absorptive agents are preferably added to the dope. The preferable UV-absorptive agent is excellent in absorption power of the UV-ray of at most 370 nm, and furthermore hardly absorbs the visible ray of at least 400 nm in view of the suitable displaying properties of the liquid crystal display. As concrete examples of the UV-absorbing agent to be used in the present invention, there are, for example, oxybenzophenone type compounds, benzotriazol type compounds, salitilic acid ester type compounds, benzophenone type compounds, cianoacrylate type compounds, nickel complex type compound and the like.

Concrete examples of benzotriazol type UV-absorbing agent are as follows: 2-(2′-hydroxy-5′-methylphenyl) benzotriazol; 2-(2′-hydroxy-3′,5′-di-tert-butylphenyl) benzotriazol; 2-(2′-hydroxy-3′-tert-butyl-5′-methylphenyl) benzotriazol; 2-(2′-hydroxy-3′,5′-di-tert-butylphenyl)-5-chlorobenzotriazol; 2-(2′-hydroxy-3′-(3″,4″,5″,6″-tetrahydrophthalimidemethyl)-5′-methylphenyl) benzotriazol; 2,2-methylenebis(4-(1,1,3,3-tetramethylbutyl)-6-(2H-benzotriazol-2-yl)phenol); 2-(2′-hydroxy-3′-tert-butyl-5′-methylphenyl)-5-chlorobenzotriazol; 2,4-dihydroxybenzophenone; 2,2′-dihydroxy-4-methoxybenzophenone; 2-hydroxy-4-methoxy-5-sufobenzophenone; bis(2-methoxy-4-hydroxy)-5-benzoylphenylmethane; (2,4-bis-(n-octylthio)-6-(4-hydroxy-3,5-di-tert-butylanilino)-1,3,5-triazine; (2′-hydroxy-3′,5′-di-tert-butylphenyl)-5-chlorobenzotriazol (2′-hydroxy-3′,5′-di-tert-amylphenyl)-5-chlorobenzotriazol; 2,6-di-tert-butyl-p-cresol; pentaerythrytyl-tetrakis[3-(3,5-di-tert-butyl-4-hydroxyphenyl)propionate]; triethylenegrycol-bis[3-(3-tert-butyl-5-methyl-4-hydroxyphenyl)propionate]; 1,6-hexanediol-bis[3-(3,5-di-tert-butyl-4-hydroxyphenyl)propionate]; 2,2-thio-diethylenebis[3-(3,5-di-tert-butyl-4-hydroxyphenyl)propionate]; octadecyl-3-(3,5-di-tert-butyl-4-hydroxyphenyl)propionate; N,N′-hexamethylenebis(3,5-di-tert-butyl-4-hydroxy-hydrocynnamide); 1,3,5-trimethyl-2,4,6-tris(3,5-di-tert-butyl-4-hydroxybenzyl)benzene; tris-(3,5-di-tert-butyl-4-hydroxybenzyl)-isocianurate; and the like. Especially preferable examples of benzotriazol type UV-absorbing agent are: (2,4-bis-(n-octylthio)-6-(4-hydroxy-3,5-di-tert-butylanilino)-1,3,5-triazine; (2′-hydroxy-3′,5′-di-tert-butylphenyl)-5 chlorobenzotriazol; (2′-hydroxy-3′,5′-di-tert-amylphenyl)-5-chlorobenzotriazol; 2,6-di-tert-butyl-p-cresol; pentaerythrytyl-tetrakis[3-(3,5-di-tert-butyl-4-hydroxyphenyl)propionate]; triethylenegrycol-bis[3-(3-tert-butyl-5-methyl-4-hydroxyphenyl)propionate].

Further, hydrazine based metal inactivators and phosphorous based processing stabilizer may be used simultaneously. The respective example of them are:

N,N′-bis[3-(3,5-di-tert-butyl-4-hydroxyphenyl)propionyl]hydrazine; and tris(2,4-di-tert-butylphenyl)phosphate.

In the present invention, however, the benzotriazol type UV-absorbing agents are not restricted in them.

Further, UV-absorbing agent may be used as described in Japanese Patent Publications No. H06-148430 & H07-11056. In the above description, the UV-absorbing agent to be preferably used in the present invention is benzotriazol based UV-absorbing agent having high transparency and high effectivities for preventing the deterioration of the polarizing filter and that of liquid crystal elements. Furthermore, in the benzotriazol type UV-absorbing agent to be used, unnecessary coloring is preferably not made. Amount of the UV-absorbing agent to be used is not always the same and depends on the sorts of compounds or conditions for use. Usually, however, the amount is preferably from 0.2 g to 5.0 g, particularly 0.4 g to 1.5 g, and especially 0.6 g to 1.0 g for preparing 1 m² of the cellulose acylate film.

As other additive compounds, there are light stabilizers shown in a catalogue of “Adekastab” in summary of additives for Asahi Denka Co., Ltd. However, there are also light stabilizers and UV-absorbing agents in a catalogue of Tinuvin of Ciba SpecialtyChemicals. Further, thereareSeesorb, Seenox, Seetec in a catalogue of Shipro Kasei Kaisha, UV-absorbing agent and antioxidants of Johoku Chemical Co., Ltd., Viosorb of Kyodo Chem. Co., Ltd., and UV-absorbing agent of Yoshitomiyakuhin Co., Ltd.

The temperature during the preparation of the cellulose acylate solution is preferably in the range of 0° C. to 150° C., particularly 0° C. to 100° C., especially 0C to 90° C., and more especially 20° C. to 90° C. Further, for preparing the cellulose acylate solution, base compounds are not used preferably. However, if the base compounds are used, it may be organic base compounds or inorganic base compounds. In this case, it is preferable to use the organic base compounds, for example, pyridine, tertiary alkylamines (especially triethylamine, ethyldiisopropylamine) and the like.

According to the optical properties of the cellulose aclyate film, preferably, the Re retardation (described in formula (IV)), the Rth retardation (described in formula (V)) respectively satisfy formulae (VI) and (VII).
Re(λ)=(nx−ny)×d (IV)
Rth(λ)=((nx+ny)/2−nz)×d (V)
46 nm≦Re(630)≦200 nm (VI)
70 nm≦Rth(630)≦350 nm (VII)

Re(λ) in the formula (IV) is an in-plane retardation (unit; nm) at wavelength λ, and Rth(λ) in the formula (V) is a thickness retardation (unit; nm) at wavelength λ. Further, nx is a refractive index in a slow axis on a film surface, ny is a refractive index in a fast axis on a film surface, nz is a refractive index in a thickness direction of the film, and d is a film thickness. Especially preferably, the retardations Re(λ) and Rth(λ) respectively satisfy the following formulae (VIII) and (IX):
46 nm≦Re(630)≦100 nm (VIII)
180 nm≦Rth(630)≦350 nm (IX)

In accordance with mass variation and size variation that are caused by the moisture fluctuation and the continuity of high temperature, the optical properties of Re and Rth varies. However, the variation is preferably smaller. In order to reduce the variation of the optical properties depending on the moisture, cellulose acylate in which a degree of acylation on 6^{th} position is large and several sorts of hydrophobic additive compounds (plasticizers, retardation controllers, UV-absorbing agents and the like) are used to make moisture permeation and equilibrium moisture content lower. The moisture permeation is preferably in the range of 400 g to 2300 g per one square meter at 60° C. for 24 hours under 95% RH. A measured value of the equilibrium moisture content is preferably at most 3.4% at 25° C. under 80% RH. Preferably, according to the variation of the optical properties, when the humidity at 25° C. is changed from 10% RH to 80% RH, it is preferable to reduce the retardations Re in 12 nm and the retardation Rth in 32 nm. Amount of hydrophobic additive compounds is preferably in the range of 10 wt. % to 30 wt. % to amount of cellulose acylate, particularly 12 wt. % to 25 wt. %, andespecially 14.5 wt. % to 20 wt. %. Further, if the additive compounds are volatile or resolvable, mass variation or size variation of the film occurs, and thus the optical properties vary. The mass variation is preferably at most 5 wt. % after the disposure at 80° C. under90% RH for 48 hours. The size variation is preferably at most 5 wt. % after the disposure at 60° C. under 95% RH for 24 hours. Furthermore, even if the mass variation and the size variation are small, the small photoelastic constant reduces the variation of the optical properties. Therefore, the photoelastic constant of the film is preferably at most 50×10⁻¹³ cm²/dyne.

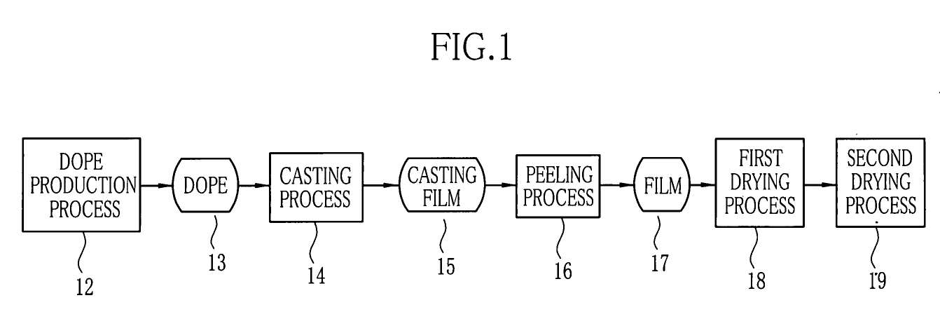

In FIG. 1, there are a dope production process 12, a casting process 14, a peeling process 16 and first and second drying processes 18, 19 for producing the cellulose acylate film of the present invention.

The dope production process 12, cellulose acylate as main component of the film is mixed with the solvent and the additive, such that a cellulose acylate solution may be obtained. Then the cellulose acylate solution is filtrated with a filtration device having a metal filter, and thus a dope 13 is obtained.

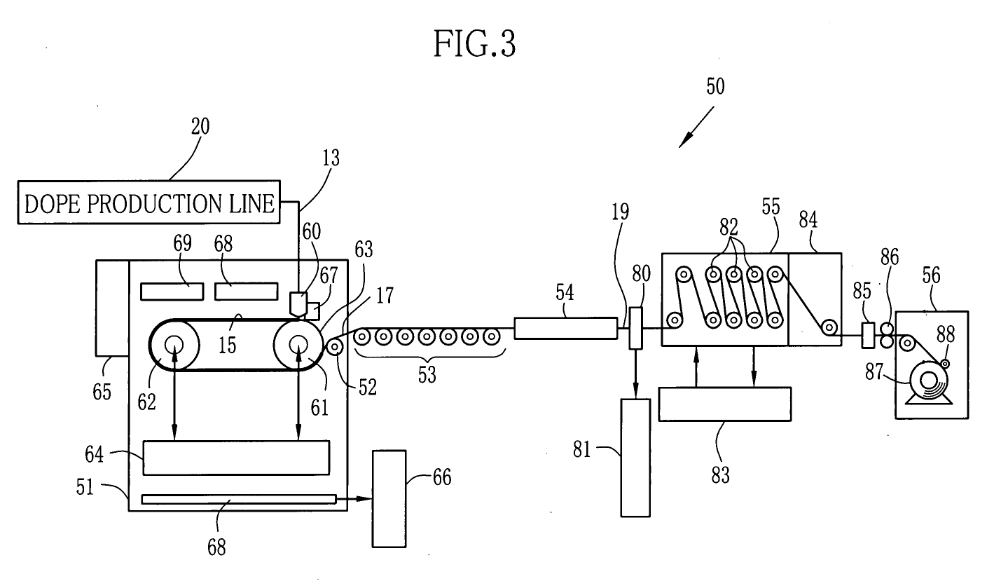

Then in the casting process 14, the dope 13 is cast onto a belt 63 (see, FIG. 3) as a support to form a casting film 15 (see, FIG. 3). After having a self-supporting property, the casting film 15 is peeled as a film 17 from the belt 63. Since the film 17 contains the solvent, the first drying process 18 is performed, in which there are several drying sections of different temperatures. Thus the evaporation of the solvent from the film 17 is made in each drying section.

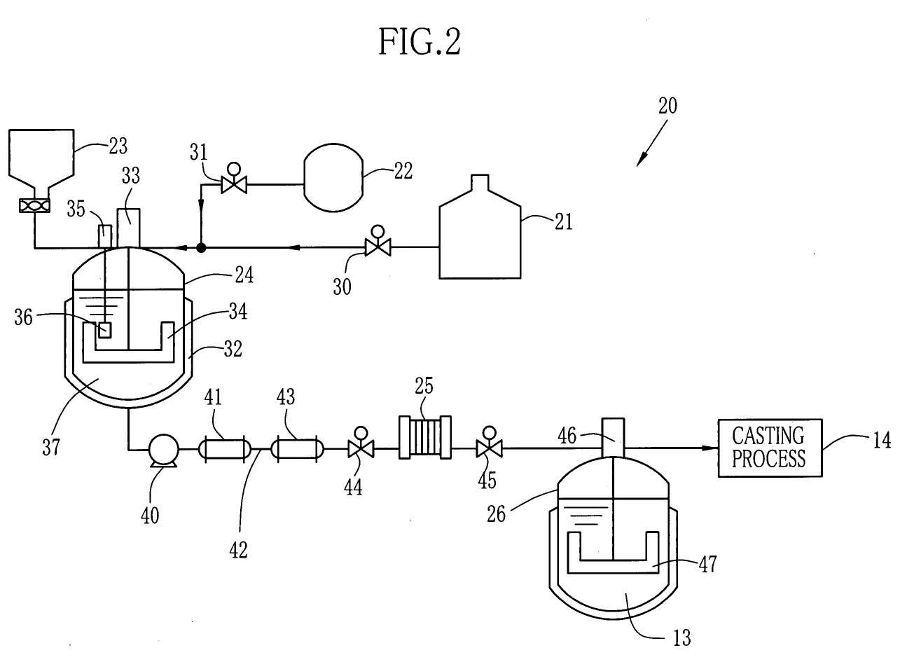

The dope production process 12 is performed in a dope production line 20, as shown in FIG. 2. Note that the production method of the dope used in the present invention is not restricted in the embodiment shown in FIG. 2. The dope production line 20 is constructed of a solvent tank 21, an additive tank 22, a hopper 23, a dissolution tank 24, a filtration device 25 and a stock tank 26. Several sorts of the devices constructing the dope production line 20 are connected through plural pipes.

The solvent tank 21, the additive tank 22 and the hopper 23 contain several materials for preparing the dope 13. In the solvent tank 21, a solvent for dissolving cellulose acylate is stored. The solvent, for example, is a mixture solvent containing dichloromethane as main solvent compound and several sorts of alcohols. In the additive tank 22, an additive is stored. As examples of additive compounds, there are plasticizers, retardation controllers, UV-absorbing agents (for example, benzotriazol type compounds), matting agents (for example, silica particles), deterioration inhibitor, optical anisotropy controller, dyes, peeling accelerators and the like. Some of them are choosen depending on objects. Further, in the hopper 23, cellulose acylate as main raw material of the film is stored.

When the valve 30 is opened, the solvent is sent from the solvent tank 21 to the dissolution tank 24. Amount of the solvent is controlled by adjusting the valve 30. Then a valve 31 is opened such that the additive is sent from the additive tank 22 to the dissolution tank 24. Thereafter, the cellulose acylate in the hopper 23 is sent to the dissolution tank 24.

If the additive is in the liquid state in the room temperature, it may be fed in the liquid state to the dissolution tank 24 without preparing for the additive solution. Otherwise, if the additive is in the solid state in the room temperature, it may be fed in the solid state to the dissolution tank 24 with use of a hopper. If plural sorts of additive compounds are used, the additive containing the plural additive compounds may be accumulated in the additive tank 22 altogether. Otherwise plural additive tanks may be used so as to contain the respective additive compounds, which are sent through independent pipes to the dissolution tank 24.

In the above explanation, the solvent, the additive, and the cellulose acylate are sequentially sent to the dissolution tank 24. However, the sending order is not restricted in it. For example, after the predetermined amount of cellulose acylate is sent to the dissolution tank 24, the feeding of the predetermined amount of the solvent and the additive may be performed to obtain a cellulose acylate solution. Otherwise, a mixture solvent may be prepared from the solvent and the additive, and mixed with cellulose acylate. Further, the solvent may be added to a mixture of the cellulose acylate and the additive. Otherwise, the additive may be added in a film production process 50 (see, FIG. 3). The method of adding the additive is not restricted.

The dissolution tank 24 is provided with a jacket 32 covering over an outer surface of the dissolution tank 24, a first stirrer 34 to be rotated by amotor 33, and a second stirrer 36 to be rotated by a motor 35. The first stirrer 34 preferably has an anchor blade, and the second stirrer 36 is preferably an eccentric stirrer of a dissolver type. The jacket is provided with a temperature controller for controlling the temperature of a heat transfer medium flowing in the jacket. Thus the inner temperature in the dissolution tank 24 is controlled. The preferable inner temperature is in the range of −10° C. to 55° C. At least one of the first and second stirrers 34, 36 is adequately chosen for performing the rotation. Thus a swelling liquid 37 in which TAC is swollen in the solvent is obtained.

In a downstream from the dissolution tank 24, the dope production line 20 further includes a pump 40, a heating device 41, a temperature controlling device 43, filtration devices 25, and the stock tank 26.

The pump 40 is driven such that the swelling liquid 37 in the dissolution tank 24 may be sent to the heating device 41 which is preferably a pipe with a jacket. Further, the heating device 41 preferably pressurizes the swelling liquid 37. While the swelling liquid 37 is continuously in only the heating condition or both of the heating and pressurizing condition, the dissolution of TAC proceeds such that a polymer solution 42 may be obtained. Note that the polymer solution 42 may be a solution in which the polymer is entirely dissolved and a swelling liquid in which the polymer is swollen. Further, the temperature of the swelling liquid 37 is preferably in the range of 0° C. to 97° C. Instead of the heat-dissolution with use of the heating device 41, the swelling liquid 37 may be cooled in the range of −150° C. to −10° C. so as to perform the dissolution, which is already known as the cool-dissolution method. In this embodiment, one of the heat-dissolution and cool-dissolution methods can be chosen in accordance with the properties of the materials, so as to control the solubility. Thus the dissolution of TAC to the solvent can be made enough. The polymer solution 42 is fed to the temperature controlling device 43, so as to control the temperature nearly to the room temperature.

Then the polymer solution is fed through a valve 44 to the filtration device 38 having a metal filter, so as to make the filtration of the polymer solution 42. The polymer solution 42 is fed through the filter material of the filtration device 28, such that impurities may be removed from the polymer solution 42. According to the metal filter, the materials and the nominal diameter are not restricted. However, the metal filter preferably has an averaged nominal diameter of at most 100 μm. The flow rate of the filtration in the filtration device 28 is preferably at least 50 little/hr. The polymer solution 42 after the filtration is fed as dope 13 through a valve 29 to the stock tank 26.

The produced dope 13 is fed to the stock tank 26 by adjusting the valve 45. The stock tank 26 has stirrer blades 47 connected to a motor 46. The stirrer blades 47 are rotary blades to stir the dope 13. Thus the situation in which several sorts of the raw materials are uniformly mixed is kept. Thereafter, the dope 13 is fed to the casting process 14 to produce the cellulose acylate film. It is preferable to perform the defoaming from the polymer solution 42 (cellulose acylate solution) and the dope 13. As the defoaming method, the methods already known may be applied. Further, the position of the defoaming is not restricted especially.

In FIG. 3, a film production line 50 includes a casting chamber 51, a peeling roller 52, an transfer section 53, a tenter dryer 55, a drying chamber 55 and a winding chamber 56. However, the present invention is not restricted in the embodiment of FIG. 3.

In the casting chamber 51, the casting process 14 is performed. The casting chamber is provided with a casting die 60, rollers 61, 62, a belt 63, a heat transfer circulating device 64, a temperature controlling device 65, a recovering device 66, a decompression chamber 67, a charging duct 68, and a discharging duct 69. The belt 63 is supported by the rollers 61, 62. The dope 13 is cast onto the belt 63 endlessly running in accordance with rotation of the rollers 61, 62. The materials of the casting die 60 are preferably double phase stainless having coefficient of thermal expansion of at most 2×10⁻⁵(° C.⁻¹). The finish precision of a contact face of the casting die to solution is at most 1 μm in surface roughness and at most 1 μm/m in straightness. The clearance of a slit of the casting die 60 is automatically adjustable in the range of 0.5 mm to 3.5 mm. According to an edge of the contact portion of a lip end of the casting die 60 to the dope, R (R is chamfered radius) is at most 50 μm in all of a width. Further, the shearing rate in the casting die is controlled in the range of 1 to 5000 per second.

A width of the casting die 60 is not restricted especially. However, the width is preferably at least 1.1 times and at most 2.0 times as large as a film width. Furthermore, the casting die 60 is preferably a coat hanger type die. Further, in order to adjust a film thickness, the casting die 60 is preferably provided with an automatic thickness adjusting device. For example, thickness adjusting bolts (heat bolts) are disposed at a predetermined interval in a widthwise direction of the casting die 60. According to the heat bolts, it is preferable that the profile is set on the basis of a predetermined program, depending on feed rate of pumps (preferably, high accuracy gear pumps), while the film production is performed. Further, the film production line 50 may be provided with a thickness meter (not shown), such as infrared ray thickness meter and the like. In this case, the feed back control of the adjustment value of the heat bolts may be made by the adjusting program on the base of the profile of the thickness meter. The thickness difference between any two points in the widthwise direction except the side edge portions in the casting film is controlled preferably to at most 1 μm. The difference between the maximum and the minimum of the thickness in the widthwise direction is at most 3 μm, and especially at most 2 μm. Further, the accuracy to the designated object value of the thickness is preferably in ±1.5 μm.

Preferably, a hardened layer is preferably formed on a top of a lip end of the casting die 60. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and no adhesiveness to the casting die 60. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of the dope 13 flowing on a slit end of the casting die 60, it is preferable to provide a solvent supplying device (not shown) at the slit end, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). Note that the pump for supplying the solvent has a pulse rate (or ripple factor) at most 5%.

The belt 63 is positioned below the casting die 60, and lapped on back-up rollers 61, 62. When the back-up rollers 61, 62 are rotated by the driving device (not shown), and thus the belt 63 runs endlessly in accordance with the rotation of the back-up rollers 61, 62. Then the casting speed is preferably in the range of 10 m/min to 200 m/min. Further, the temperatures of the back-up rollers 61, 62 are controlled by the heat transfer medium circulator 64 for cycling a heat transfer medium. It is preferable that the surface temperature of the belt 63 is adjusted in the range of −20° C. to 40° C. by heat transmission from the back-up rollers 61, 62. In this embodiment, paths (not shown) of the heat transfer mediums are formed in the back-up rollers 61, 62, and the heat transfer mediums whose temperatures are controlled by the heat transfer medium circulator 64 pass through the paths. Thus the temperature of the back-up rollers 61, 62 are kept to the predetermined values.

The width, the length and the material of the belt 63 are not restricted especially. However, it is preferably 1.1 to 3.0 times as large as the casting width. Preferably, the length is from 10 m to 200 m, and the thickness is from 0.3 mm to 10 mm. The surface is preferably polished so as to have a surface roughness at most 0.05 μm. The belt 63 is preferably made of stainless steel, and especially of SUS 316 so as to have enough resistance of corrosion and strength. The thickness unevenness of the entire belt 63 is preferably at most 0.5%.

At this moment, the tension of the belt 63 was controlled to 1.5×10⁴ kg/m. Further, the relative speed to each roller to the belt 63 changed. However, in this experiment, the control was made such that the difference of the relative speed between the back-up rollers 61, 62 was at most 0.01 m/min. Further the control was made such that the variation of the speed of the belt 63 was at most 0.5% to the predetermined value. The position of the belt in the widthwise direction was controlled with detection of the position of the side end, such that meandering in one circle of the moving belt 63 was reduced in 1.5 mm. Further, below the casting die 60, the variation of the position in the vertical direction between the lip end of the casting die and the belt 63 was in 200 μm. The belt 63 is preferably incorporated in a casting chamber 76 which has air pressure controller (not shown). The three dopes (for forming the uppermost, intermittent and lower most layers) were cast onto the belt 63 from the casting die 60.

Note that it is possible to use one of the back-up rollers 61, 62 as support. In this case, the back-up roller used as support is preferably rotated at high accuracy such that a rotation flutter may be at most 0.2%. Therefore the surface roughness is preferably at most 0.01 μm. Further, the chrome plating is preferably performed to the drum such that the drum may have enough hardness and endurance. As described above, it is preferable in the support that the surface defect must be reduced to be minimal. Concretely there are no pin hole of at least 30 μm, at most one pin hole in the range of 10 μm to 30 μm, and at most two pin holes of less than 10 μm per 1 m².

The temperature controlling device 65 is provided for controlling the inner temperature of the casting chamber 51 to the predetermined value and the condenser 68 for condensing organic solvent evaporated in the casting chamber 51. Further the recovering device 66 for recovering the condensed organic solvent outside the casting chamber 64. When the recovery solvent is used as the solvent for the dope preparation as described above, the cost for the material becomes lower, and therefore the production cost becomes lower.

The dope 13 is cast from the casting die 60 onto the belt 63, so as to form the casting film 15. At the casting, the temperature of the dope 13 is preferably controlled in the range of −10° C. to 57° C. Further, in order to stabilize the formation of a bead of the cast dopes, there is a decompression chamber 68 for controlling the pressure in the back side of the bead. It is preferable to provide the decompression chamber 68 with a jacket (not shown) for controlling the inner temperature. The temperature of the decompression chamber 68 is not restricted especially. However, the temperature is preferably in the range of +10° C. to 50° C.

The casting belt 63 runs to convey the casting film 15. During the conveyance, in order to evaporate the solvent in the casting film 15, it is preferable to provide a charging duct (not shown) for charging air. The position of the charging duct is not restricted especially. However, it is in an upper and upstream side, an upper and downstream side, and a lower side of the casting belt 63. Further, an air shielding device (not shown) is disposed close to the belt 63 in the downstream side from the casting die 60. The air shielding device reduces the change of the surface conditions of the casting film 15. Note that the casting belt 63 is used as the support of the casting film 15. However, the support is not restricted in this embodiment, and a drum like the back-up roller may be used as the support. In this case, the surface temperature of the drum is preferably in the range of −20° C. to 40° C.

When the cast dope has self-supporting property, the casting film 15 is continuously peeled as the film 17 with support of the peeling roller 52. The peeling roller 63 is a driving roller. Then the film 17 is transported in the transfer section 53 in which many rollers are provided, and thus transported into the tenter dryer 54.

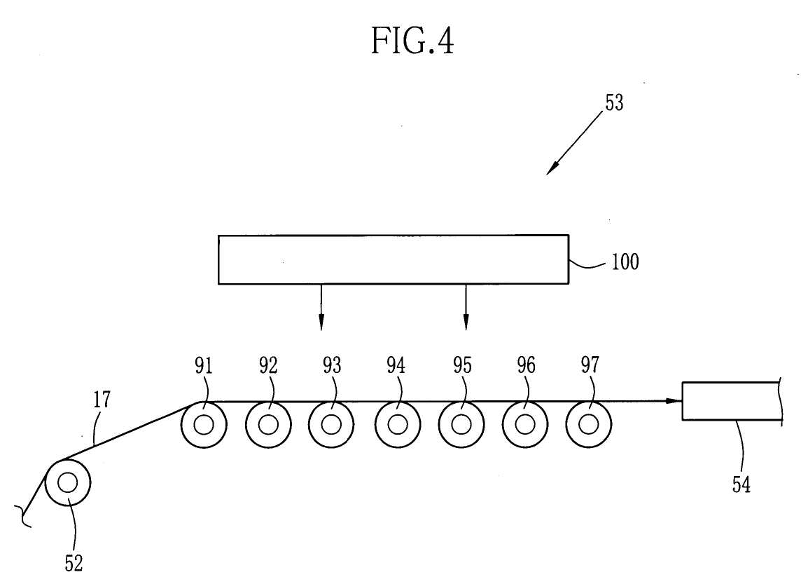

As shown in FIG. 4, the transfer section 53 includes first to seventh rollers 91-97 from the downstream side, and an air blower 100. While the film 17 is transported with the support of the rollers 91-97, a drying air is fed from the air blower to dry the film 17. Preferably, each roller 91-97 is a driving roller, and the temperature of the drying air is in the range of 20° C. to 250° C. Note that each roller 91-97 may be a non-driving roller. Further, in the transfer section 53, the rotating speed of the roller may be set to be higher in the downstream side, so as to draw the film 17. In this embodiment, there are seven rollers. In the present invention, the number thereof is preferably from 2 to 20. If the number is less than 2, the drying time and the transportation distance are too short, and therefore it is hard to dry the film 17 enough. If the number is more than 20, the large equipment is necessary, and therefore the cost for the equipment becomes higher. Further, the rollers are preferably disposed to both sides of the transport path in staggered arrangement. However, the number, the arrangement, and further the shape of the rollers are not restricted especially.

In the present invention, the temperatures of rollers 91-97 are independently controlled. The temperature control of the rollers 91-07 may be made by respective temperature controlling devices, or by a single temperature controlling device. Inside of each roller 91-97, for example, there is a flow passage in which a heat transfer medium (for example, water) flows for controlling the surface temperature of each roller 91-97. Thus the transportation of the film 17 in the transfer section 53 can be made stably. Namely, the transportation is made without unnecessary stress to the film 17, while the drying proceeds. Thus the generation of the wrinkles and the creases on the film 17 in the transfer section 53 is reduced and the drying is made.

If the melting point of the additive for the dope 13 is described as Tm (° C.), the temperature of each roller 91-97 is controlled preferably in the range of Tm (° C.) to Tm+50 (° C.), particularly Tm (° C.) to Tm+30 (° C.), and especially Tm (° C.) to Tm+20 (° C.). Note that if plural additive compounds are used, the lowermost melting point among them is determined as Tm (° C.). If the temperature of each roller 91-97 is less than Tm (° C.), the solvent vapor contacting to the rollers 91-97 makes the adhesion or the disposition on the surface of the rollers 91-97. Thus the surface defect occurs. Otherwise, if the temperature of each roller 91-97 is more than Tm+50 (° C.), the temperature is too high, and therefore the decomposition or the deterioration of polymer in the film occurs. Further, the contained additive evaporates too much, and thus the produced film cannot have enough functions. However, it is not necessary to control the temperature of all rollers 91-97 to the same value. The temperatures of all rollers may be at least the melting point of the used additive. For example, if it is designated to use TPP (boiling temperature, 50° C.) as the plasticizer, the temperature of each roller 91-97 is controlled in the range of 50° C. to 100° C., so as to dry the film 17.

In order to transport in the tenter dryer 54, the film 17 is held by clipping both side edge portions, and at the same time the second drying process 19 is made to evaporate the solvent. For the second drying process 19, temperature controller (not shown) is provided for the tenter device 54 such that an inner temperature of the tenter dryer 54 may be controlled. An inner temperature of the tenter dryer 54 can be changed along the transportation path, such that an ambient temperature of the transported film 17 is controlled. For example, a plurality of air ducts for feeding out drying airs is disposed along the transportation path, and a temperature of the drying air is controlled at each air duct. In the tenter dryer 54, the stretching of the film 17 in the widthwise direction may be made during the transport and the drying. In this case, in the transfer section or/and the tenter dryer 54, the stretching in the widthwise direction and the drawing in the lengthwise direction are made such that the width and the length may be in the range of 0.5% to 300% larger than the original size. Further, when it is designated to make the stretching and the drawing, it is preferable to make a relaxation of the film thereafter. When the stretching and the relaxation are performed, both side portions are held. When both side edge portions are held before the stretching, film width is described as L1(mm), and when the film is stretched maximally, film width is described as L2(mm). Further, when both side edge portions are releases from the holders after the relaxation, film width is described as L3(mm). The film stretching is preferably made with satisfying a condition of 1<{(L2−L3)/L1}×100<15.

In the tenter device 54, while a width of the film 17 changes in the tenter dryer 54, it is preferable to reduce a fluctuation of the inner temperature in ±1° C. from a predetermined temperature. Thus the generation of surface defects, such as creases, wrinkle and the like, is prevented. When the stretching and the relaxation are made, it is preferable to keep the heating temperature of the film 17 to the predetermined value in the range of 50° C. to 180° C.

The film 17 is dried until the content of the remaining solvent become the predetermined value, and fed out from the tenter dryer 54 toward an edge slitting device 80 for slitting off both side edge portions. The slit side edge portions are sent to a crusher 81 by a cutter blower (not shown), and crushed to tips by the crusher 81. The tips are reused for preparing the dope, which is effective in view of the decrease of the production cost. Note that the slitting process of both side edge portions may be omitted. However, it is preferable to perform the slitting between the casting process and the winding process.

The film 17 whose side edge portions are slit off is sent to a drying device 55 and dried furthermore. In the drying device 55, the film 17 is transported with lapping on rollers 82. The inner temperature of the drying chamber 55 is not restricted especially. However, it is preferable in the range of 50° C. to 180° C. The solvent vapor evaporated from the film 17 by the drying device 55 is adsorbed by an adsorbing device 83. The air from which the solvent components are removed is reused for the drying air in the drying device 55. Note that the drying device 55 preferably has plural partitions for variation of the drying temperature. Further, a pre-drying device (not shown) is provided between the edge slittihg device 80 and the drying device 55, so as to perform the pre-drying of the film 17. Thus it is prevented that the temperature of the film 17 increases rapidly, and therefore the change of the shape of the film 17 is reduced.

The film 17 is transported into a cooling chamber 84, and cooled therein to around the room temperature. A humidity control chamber (not shown) may be provided for conditioning the humidity between the drying device 55 and the cooling chamber 84. Preferably, in the humidity control chamber, an air whose temperature and humidity are controlled is applied to the film 17. Thus the curling of the film 17 and the winding defect in the winding process can be reduced.

Thereafter, a compulsory neutralization device (or a neutralization bar) 85 eliminates the charged electrostatic potential of the film 17 to the predetermined value (for example, in the range of −3 kV to +3 kV). The position of the neutralization process is not restricted in this embodiment. For example, the position may be a predetermined position in the drying section or in the downstream side from a knurling roller 86, and otherwise, the neutralization may be made at plural positions. After the neutralization, the embossing of both side portions of the film 17 is made by the embossing rollers to provide the knurling. The emboss height from the bottom to the top of the embossment is in the range of 1 μm to 200 μm.

In the last process, the film 17 is wound by a winding shaft 87 in the winding chamber 56. At this moment, a tension is applied at the predetermined value to a press roller 88. Preferably, the tension is gradually changed from the start to the end of the winding. In the present invention, the length of the film 17 is preferably at least 100 m. The width of the film is preferably at least 600 mm,;and particularly in the range of 1400 mm to 1800 mm. Further, even if the width is more than 1800 mm, the present invention is effective.

Note that the method of producing the polymer solution is disclosed in detail in [0517] to [0616] in Japanese Patent Laid-Open Publication No. 2005-104148, for example, the dissolution method and the adding methods of the materials, the raw materials and the additives in the solution casting method for forming the TAC film, the filtering method, the bubble removing method, and the like.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways. It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

Conditions and Methods for forming the functional layer are described in detail from [0890] to [1087] of Japanese Patent Laid-Open Publication No. 2005-104148, which can be applied to the present invention. Thus, the produced film can have several functions and properties.

These functional layers preferably contain at least one sort of surfactants in the range of 0.1 mg/m² to 1000 mg/m². Further, the functional layers preferably contain at least one sort of plasticizers in the range of 0.1 mg/M² to 1000 mg/M². The functional layers preferably contain at least one sort of matting agents in the range of 0.1 mg/m² to 1000 mg/M². The functional layers preferably contain at least one sort of antistatic agents in the range of 1 mg/M² to 1000 mg/M².

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention.

Further, in the description of this application, a cellulose acylate film is provided with an optically anisotropic layer, and another cellulose acylate film is provided with antireflective and antiglare functions. Further, the publication describes about the optically biaxial cellulose acylate film provided with adequate optical properties. This cellulose acylate film may be used with the protective film for the polarizing filter. These descriptions of the Laid-Open Publication No. 2005-104148 continues from [1088] to [1265], which can be applied to the present invention.

Further, the difference of the slow axis between optional area of the produced film and all of next areas of the optional area is preferably less than 2.0 degree, and especially less than 1.0 degree. Further, when it is designated to produce the film whose thickness is in the range of 15 μm to 100 μm, the present invention also can be applied.

In the method of forming the polymer film of the present invention, the formed cellulose acylate film is excellent in optical properties. The TAC film can be used as the protective film for the polarizing filter, a base film of the photosensitive material, and the like. Further, in order to improve the view angular dependence of the liquid crystal display (used for the television and the like), the produced film can be also used for the optical compensation film. Especially, the produced film is effectively used when it doubles as protective film for the polarizing filter. Therefore, the film is not only used in the TN-mode as prior mode, but also IPS-mode, OCB-mode, VA-mode and the like. Further, the polarizing filter may be constructed so as to have the protective film as construction element.

According to the present invention, experiment was made and the explanation thereof will be made in followings. However, the present invention is not restricted in the explanation. The explanation will be made in detail according to Example 1. about another examples and comparisons, the same experiment will be omitted as Example 1.

[Experiment]

### EXAMPLE 1

In order to produce the cellulose acylate film, following compounds are used to prepare the dope 13 in the dope production line 20 of FIG. 2.

| | | |
|---|---|---|
| Cellulose Triacetate | 20 | pts. wt. |
| Methyl acetate | 58 | pts. wt. |
| Acetone | 5 | pts. wt. |
| Methanol | 5 | pts. wt. |
| Ethanol | 5 | pts. wt. |
| Butanol | 5 | pts. wt. |
| UV-agent A | 0.2 | pts. wt. |
| (2,4-bis-(n-octylthio)-6-(4-hydroxy-3,5-di-tert- | | |
| butylanylino)-1,3,5-triazine) | | |
| UV-agent B | 0.2 | pts. wt. |
| (2(2′-hydroxy-3′,5′-di-tert-butylphenyl)-5- | | |
| chlorobenzotriazol) | | |
| UV-agent C | 0.2 | pts. wt. |
| (2(2′-hydroxy-3′,5′-di-tert-amylphenyl)-5- | | |
| chlorobenzotriazol) | | |
| Peeling agent A (C₁₂H₂₅OCH₂CH₂O-P(═O)—(OK)₂) | 0.02 | pts. wt. |
| Peeling agent B (Citric acid) | 0.02 | pts. wt. |
| Particles (Silicon dioxide) | 0.05 | pts. wt. |
| (particle diameter, 20 nm; Mohs Hardness, about 7) | | |

Further the predetermined amount of the plasticizer and the retardation controller were set to the dissolution tank 24. After the mixing enough, the mixture was heated by the heating device 41 to be the polymer solution 42 as the cellulose acylate solution. Then the filtration of the polymer solution 42 was made to obtain the dope 13. Note that the addition amount of the plasticizer and the retardation controller will be described later.

The dope 13 was used for producing the film 17 in the film production line 50. The dope 13 was cast from the casting die 60 onto the running belt 63, so as to form the casting film 15. The casting die 60 was the coat hanger type die, and the temperature thereof was kept to 36° C. In the casting die 60, heat bolts for adjusting the film thickness were disposed at the pitch of 20 mm. When having the self-supporting property, the casting film 15 was peeled as the film 17 with use of the peeling roller 52. As shown in FIG. 4, the film 17 was fed into the transfer section 53. While thefilm 17 was transported with support of the rollers 91-97, the drying air was fed to the film 17 by the air blower 100. After the transfer section 53, the film 17 was fed into the tenter dryer 54 such that the drying might be made furthermore. The inner temperature (Tf) of the tenter dryer 54 was controlled to 140° C. While both side edge portions of the film 17 were clipped, the transportation of the film 17 was made with tension of 20 kg/m applied in the widthwise direction. Thus the film 17 was fed out from the tenter dryer 54. Thereafter the film 17 was transported with support of the rollers 82 and dried enough in the drying chamber 55. Then the film 17 was fed as the film 17 in to the cooling chamber 84. After cooled to the room temperature therein, the film 17 was wound around the winding shaft 87.

In Example 1, the additives to the dope 13 were the retardation controller (additive A, AD-A) and the plasticizer (additive B, AD-B). Amount ratios (PHR) of the additives A&B to the cellulose acylate were respectively 4.2 PHR and 10.7PHR (while the amount of the cellulose acylate was described as 100 pts.mass). In this case, the boiling points of the additive A and the additive B are respectively −12° C. to 50° C. Therefore, among the rollers 91-97, the temperatures of the first, third, fourth and sixth rollers 91, 93, 94, 96 were respectively controlled to 60° C., 65° C., 67° C. and 70° C., and the temperature of all the other rollers (namely second, fifth and seventh rollers 92, 94, 95, 97) was controlled to 100° C. Thus the drying of the film 17 was made. In followings, the temperatures of the first, third, fourth and sixth rollers 91, 93, 94, 96 are called “roller conditions (PR-conditions)”.

### EXAMPLE 2

The cellulose acyalte film was produced from the same raw materials and in the same production conditions as in Example 1. The roller conditions were the same as Example 1. However, the amount ratios (PHR) of the additives A&B were 4.2 PHR and 11.7PHR for producing the film 17.

### EXAMPLE 3

The cellulose acyalte film was produced from the same raw materials and in the same production conditions as in Example 1. However, according to the roller conditions, the temperatures of the first, third, fourth and sixth rollers 91, 93, 94, 96 were respectively controlled to 67° C., 67° C., 70° C. and 70° C.

### EXAMPLE 4

The cellulose acyalte film was produced from the same raw materials and in the same production conditions as in Example 1. The roller conditions were the same as Example 3. However, the amount ratios (PHR) of the additives A&B were 4.2PHR and 11.7PHR for producing the film 17.

### EXAMPLE 5

The cellulose acyalte film was produced from the same raw materials and in the same production conditions as in Example 1. The roller conditions were the same as Example 1. However, the amount ratios (PHR) of the additives A&B were 5.1 PHR and 10.7 PHR for producing the film 17.

### EXAMPLE 6

The cellulose acyalte film was produced from the same raw materials and in the same production conditions as in Example 1. The roller conditions were the same as Example 1. However, the amount ratios (PHR) of the additives A&B were 5.1 PHR and 11.7 PHR for producing the film 17.

### EXAMPLE 7

The cellulose acyalte film was produced from the same raw materials and in the same production conditions as in Example 1. However, according to the roller conditions, the temperatures of the first, third, fourth and sixth rollers 91, 93, 94, 96 were respectively controlled to 67° C., 67° C., 70° C. and 70° C. The amount ratios (PHR) of the additives A&B were 5.1 PHR and 10.7 PHR for producing the film 17.

### EXAMPLE 8

The cellulose acyalte film was produced from the same raw materials and in the same production conditions as in Example 1. However, according to the roller conditions, the temperatures of the first, third, fourth and sixth rollers 91, 93, 94, 96 were respectively controlled to 67° C., 67° C., 70° C. and 70° C. The amount ratios (PHR) of the additives A&B were 5.1 PHR and 11.7 PHR for producing the film 17.

### Comparison 1

The cellulose acyalte film was produced from the same raw materials and in the same production conditions as in Example 1. However, according to the roller conditions, the temperatures of the first, third, fourth and sixth rollers 91, 93, 94, 96 were respectively controlled to 30° C., 35° C., 40° C. and 45° C. The amount ratios (PHR) of the additives A&B were 4.2 PHR and 10.7 PHR for producing the film 17.

### Comparison 2

The cellulose acyalte film was produced from the same raw materials and in the same production conditions as in Example 1. However, according to the roller conditions, the temperatures of the first, third, fourth and sixth rollers 91, 93, 94, 96 were respectively controlled to 30° C., 35° C., 40° C. and 45° C. The amount ratios (PHR) of the additives A&B were 4.2 PHR and 11.7 PHR for producing the film 17.

### Comparison 3

The cellulose acyalte film was produced from the same raw materials and in the same production conditions as in Example 1. However, according to the roller conditions, the temperatures of the first, third, fourth and sixth rollers 91, 93, 94, 96 were respectively controlled to 30° C., 35° C., 40° C. and 45° C. The amount ratios (PHR) of the additives A&B were 5.1 PHR and 10.7 PHR for producing the film 17.

### Comparison 4

The cellulose acyalte film was produced from the same raw materials and in the same production conditions as in Example 1. The amount ratios PHR of the additives were the same as Example 1. However, the heating of the rollers 91-97 wasn't made.

### ESTIMATION OF EFFECTS OF THE PRESENT INVENTION

In the present invention, the surface of the produced film was observed with eyes, to know whether there were roll-print defects or scratch defects. According to the roll-print defects, the estimation was made, depending on the amount of the materials adhered to the film surface: there were almost no defects, (A); there were extremely slight defects (B); there were slight defect, but the film property was not bad (C); and the film property was bad (F). According to the scratch defects, the estimation was made: there were extremely slight defects (A); there were slight defect, but the film property was not bad (B); and the film property was bad (F).

The conditions and the results of Experiment are shown in Table 1. Note that the additive A and the additive B are respectively described as AD-A and AD-B, and the temperatures 10 of the first, third, fourth, and sixth rollers 91, 93, 94, 96 are respectively described as TA, TB, TC and TD.

TABLE 1

| | PHR | | PR-Conditions (° C.) | | | | Tf | Film Property | |
|---|---|---|---|---|---|---|---|---|---|
| | AD-A | AD-B | TA | TB | TC | TD | (° C.) | DR | DS |
| Ex. 1 | 4.2 | 10.7 | 60 | 65 | 67 | 70 | 140 | B | A |
| Ex. 2 | 4.2 | 11.7 | 60 | 65 | 67 | 70 | 140 | B | A |
| Ex. 3 | 4.2 | 10.7 | 67 | 67 | 70 | 70 | 140 | A | A |
| Ex. 4 | 4.2 | 11.7 | 67 | 67 | 70 | 70 | 140 | A | A |
| Ex. 5 | 5.1 | 10.7 | 60 | 65 | 67 | 70 | 140 | B | A |
| Ex. 6 | 5.1 | 11.7 | 60 | 65 | 67 | 70 | 140 | B | A |
| Ex. 7 | 5.1 | 10.7 | 67 | 67 | 70 | 70 | 140 | B | A |
| Ex. 8 | 5.1 | 11.7 | 67 | 67 | 70 | 70 | 140 | B | A |
| Co. 1 | 4.2 | 10.7 | 30 | 35 | 40 | 45 | 140 | F | F |
| Co. 2 | 4.2 | 11.7 | 30 | 35 | 40 | 45 | 140 | F | F |
| Co. 3 | 5.1 | 10.7 | 30 | 35 | 40 | 45 | 140 | F | F |
| Co. 4 | 4.2 | 10.7 | —* | — | — | — | 140 | C | B |

“—”: not heating

As shown also in Table 1, in order to know about the effects of the temperature control of each roller 91-97, the roller conditions (PR-Condition) were at least Tm (° C.)in Examples 1-8, and at most 45° C. in Comparisons 1-3 (namely, at least 60° C. in this Experiment). Further, In Comparison 4, the rollers 91-97 were not heated (there were no temperature control), and only the feeding the air from the air blower 100 was made to produce the film 17. As the results, in Examples 1-8, there were no defects which makes impossible to use the film 17 (Estimation was A or B). However, in Comparisons 1-3, because of the defects, the film couldn't use. Further, in Comparison 4 as the prior art, the film 17 could use but the observed defects were relatively many.

[Influence of Temperature of Rollers]

As in Examples 1-8, when the temperature of each drying roller 91-97 is heated to at least the melting point Tm (° C.) of the additives of the dope 13 (in the experiment at least 60 ° C.), there were no defects on the film surface and the film property of the produced film was excellent. At this time, not only the bad effect on the defects reduces, but also the transportation in the transfer section 53 was made stably. This tendency was clearly observed when Examples 1, 3, and Comparison 1 (these three are group A) are compared to Examples 2, 4 and Comparison 2 (these three are group B). Namely, according to group A, in Example 3 in which the averaged temperature of the rollers were the largest, the estimation about the roll-print defects is A. In Example 3 in which the averaged temperature were little lower than Example 1, the estimation about the roll-print defects is B. In Comparison 1 in which the roller conditions were at most than 45° C., the estimation about the roll-print defects is F. Also in the group B in which the added amount of the additive was larger in average, the same tendency was observed.

As described above, when the film is dried with support by the rollers whose temperature is respectively controlled, the surface defect is reduced, and the transportation becomes stable in the film production. Note that when the roller condition is at least than the melting point Tm (° C.), the effect of the present invention becomes much larger.

Various changes and modifications are possible in the present invention and may be understood to be within the present invention.

What is claimed is:

1. A film production method with use of a polymer solution containing polymer, solvent and additive, comprising steps of:
casting said polymer solution onto a running support to form a casting film;
continuously peeling from said support said casting film as a film in a situation of containing said solvent; and
performing a first drying of said film by a plurality of rollers whose temperatures are independently controlled.

2. A film production method according to claim 1, wherein when melting point of said additive is described as Tm (° C.), a temperature of each of said rollers is in the range of Tm (° C.) to Tm+50 (° C.).

3. A film production method according to claim 1, further comprising steps of:
heating said film by a tenter dryer after the first drying so as to perform a second drying, said tenter dryer stretching and relaxing said film in a widthwise direction while transporting said film; and
controlling an ambient temperature of said film almost to a predetermined value while a width of said film is changed by stretching and relaxing.

4. A film production method according to claim 1, wherein said polymer is cellulose acylate.

5. A polymer film produced by said film production method according to claim 1.
